(19) United States
(12) Patent Application Publication
(10) Pub. No.: US 2017/0159637 A1
(43) Pub. Date: Jun. 8, 2017

(54) Hydrostatic Axial Piston Machine with Control Disk

(71) Applicant: Robert Bosch GmbH, Stuttgart (DE)

(72) Inventor: Josef Kopecki, Herrenberg (DE)

(21) Appl. No.: 15/364,932

(22) Filed: Nov. 30, 2016

(30) Foreign Application Priority Data
Dec. 3, 2015 (DE) 10 2015 224 132.7

(51) Int. Cl. F03C 1/06; F04B 1/22; F04B 1/20

(52) U.S. Cl. CPC F03C 1/0639; F04B 1/2035; F04B 1/2078; F04B 1/22; F03C 1/0668

(57) ABSTRACT

A hydrostatic axial piston machine includes a control disk that has a permanent relief field and at least one hydrostatic auxiliary relief field.

This application claims priority under 35 U.S.C. §119 to patent application no. DE 10 2015 224 132.7, filed on Dec. 3, 2015 in Germany, the disclosure of which is incorporated herein by reference in its entirety.

### BACKGROUND

The disclosure relates to a hydrostatic axial piston machine having a cylinder drum and having a control disk.

In principle, a hydrostatic axial piston machine can be operated as a motor or as a pump. An axial piston machine of swashplate type of construction has an inner cylinder drum with multiple cylinder bores in which pistons are movable in an axial direction. The stroke of the pistons is realized owing to the mounting of the pistons on a swashplate by way of slide shoes. On the side of the cylinder bore ducts, there is seated between the cylinder drum and the housing a control disk, on which a high-pressure side or low-pressure side is realized on a region of a first semicircle. The opposite pressure side (high/low pressure) in relation to the first semicircle is situated on a second semicircle.

Owing to the high operating pressures of up to 500 bar, the control disk is pressed against the cylinder drum. During engine operation, pressure medium is pressed, at the high-pressure side, into the stroke chambers, whereby the cylinder drum is set in a rotational motion by way of axial movement of the pistons and oblique positioning of the swashplate. The torque that is generated is output to the drive-output shaft. By contrast, during pump operation, by way of an input torque at the driveshaft, the pressure medium is drawn from the low-pressure side into the cylinder bores by the pistons. Owing to the rotation of the cylinder drums and a fixed pivot angle, the pressure medium in the stroke chamber is displaced to the high-pressure side as a result of the axial movement of the piston, which results in a pressure increase.

Owing to the friction forces of the outwardly sliding pistons on the high-pressure side, the pressure on the control disk is increased during pump operation in relation to motor operation. To reduce friction forces and wear between the rotating cylinder drum and the static control plate, hydrostatic relief means are known from the prior art.

A hydrostatic axial piston machine having a control disk, having a permanent relief field and having at least one auxiliary relief field for the cylinder drum is described in the document DE 10 2010 006 895 A1. In said document, one or more auxiliary relief fields can be activated along with the permanent relief field, or deactivated, in a manner dependent on the selected operating state (pump/motor). During motor operation, a lesser relief action is sought, such that one or more auxiliary relief fields can be switched into an unpressurized state. This prevents the relief action from becoming too intense during motor operation, while however ensuring an adequate relief action during pump operation.

A disadvantage of said solution is that the relief action can be adapted only to particular operating states. Other disruptions resulting from load alterations, such as arise for example in a load cycle in motor/pump operation with varying rotational speeds, cannot be eliminated by way of the features of the document DE 10 2010 006 895 A1.

### SUMMARY

The present disclosure is therefore based on the object of realizing a hydrostatic axial piston machine with hydrostatic auxiliary relief means, which solves rotational-speed-dependent problems that arise for example within a load cycle, such that disruption-free and tilt-free rotation of the cylinder drum on the control disk can be ensured.

According to the disclosure, said object is achieved with a hydrostatic axial piston machine which has a control disk against which a rotating cylinder drum can be held in contact, wherein, in addition to a permanent relief field, at least one hydrostatic auxiliary relief field is realized which can be supplied with pressure medium by way of a pressure medium supply. According to the disclosure, the relief pressure of the at least one auxiliary relief field is set in a manner dependent on a rotational speed of the cylinder drum. With an embodiment which is simple in terms of apparatus, the relief pressure of the at least one auxiliary relief field can be activated and deactivated in a simple manner.

The hydraulic permanent relief field has a hydrostatic and a hydrodynamic component. At rotational speeds below 250 rpm, the hydrodynamic component of the permanent relief action breaks down. The remaining, hydrostatic fraction of the permanent relief action is not sufficient to maintain liquid friction. Instead, boundary/mixed friction or even solid-state friction arises, in the case of which, without the rotational-speed-dependent auxiliary relief action according to the disclosure, results in severe wear phenomena on the control disk. An advantage of the solution according to the disclosure is that the omitted hydrodynamic component of the permanent relief action can be replaced by a purely hydrostatic component of the at least one auxiliary relief field.

The hydrostatic auxiliary relief field is particularly highly suitable for compensating rotational-speed-dependent disturbance variables. Such disturbance variables may for example be forces and moments. Such disturbance variables may arise in particular in the range of very low or very high rotational speeds. A disturbance variable is for example, as described above, the increased friction as a result of omission of the hydrodynamic component of the relief action at very low rotational speeds close to zero. A further disturbance variable is the reversal of the friction force vectors upon a change from pump operation to motor operation. Here, in the worst case, the cylinder drum may be pulled from the control disk. A third disturbance variable is a tilting moment which arises as a result of very high rotational speeds of the axial piston machine. Here, the centrifugal forces that act on the piston become continuously higher, such that, owing to the pistons being deployed to different extents, the running surface of the cylinder drum becomes increasingly obliquely inclined on the running surface of the control disk. When a lift-off rotational speed is reached, the tilting moment becomes so high that the cylinder drum lifts off from the control disk at one side.

An exemplary embodiment is particularly preferable in which the pressure medium supply has a pressure medium flow limitation means.

By way of the pressure medium flow limitation means, the pressure that is available to the auxiliary relief field is reduced. As a result, a limiting pressure medium flow in combination with the pressing force of the cylinder drum against the control disk ensures a smaller gap dimension between the running surfaces of the cylinder drum and of the control disk. The nozzle may be used in combination with an auxiliary pump as pressure medium supply.

It is preferable for a non-adjustable nozzle to be arranged upstream of the pressure medium inlet of the hydraulic auxiliary relief field, which nozzle limits the pressure medium flow and reduces the relief pressure. Here, a nozzle diameter of 0.4 mm is particularly preferable, though nozzle diameters from 0.1 to 0.8 mm are basically also conceivable.

As an alternative to a non-adjustable nozzle, use is particularly preferably made of an adjustable nozzle for controlling the relief pressure in the auxiliary relief field and thus the auxiliary relief force. By way of the adjustable nozzle, the pressure supplied from the high-pressure side of the control disk can be reduced.

An embodiment is particularly preferable in which the pressure medium is drawn or picked off via a high-pressure side of the axial piston machine.

A particular advantage of this solution is that it is possible to dispense with further hydraulic components such as pumps or accumulators. In the case of the pressure being picked off on the high-pressure side of the axial piston machine, the above-described adjustable nozzle is preferably used. Owing to the coupling of the auxiliary relief field to the high-pressure side of the axial piston machine, an adjustment capability is thus realized for enabling the relief pressure of the auxiliary relief field to be controlled, according to the disclosure, in a manner dependent on the rotational speed. There are basically two adjustment types that may be realized. Firstly, the pressure may be raised, by way of the adjustable nozzle, until complete relief of the auxiliary relief field with simultaneous minimization of the pressure medium flow is realized, or it is possible, by way of the dimensioning of the auxiliary relief field, for the hydraulic resistance thereof, which is defined by the gap dimension between the auxiliary relief field and the cylinder drum, to be lowered. In this way, the pressure medium flow is determined primarily by the resistance characteristics of, for example, the nozzle, which impart a defined pressure medium film height to the auxiliary relief field.

The auxiliary relief field is preferably connected to a hydraulic accumulator and/or to a hydraulic pump, in particular auxiliary pump.

Since, in the case of these embodiments, there is no coupling of the hydrostatic auxiliary relief field to the operating pressure of the axial piston machine according to the disclosure, it is possible for the relief pressure of the auxiliary relief field to be controlled by way of the adjustability of the auxiliary pump. Alternatively to or in parallel with the auxiliary pump, a hydraulic accumulator may also be used. The latter may release the stored hydraulic energy back to the system, in particular may release said hydraulic energy to the auxiliary relief field. In this embodiment, the abovementioned non-adjustable nozzle is preferably used.

Other combinations, such as for example non-adjustable nozzle, high-pressure pick-off, adjustable nozzle, auxiliary pump or hydraulic accumulator are however also conceivable.

In general, in a hydrostatic axial piston machine, internal losses (leakage) of pressure medium or oil, for example an oil spray process in the housing of the axial piston machine, occur. Said discharged oil is preferably used for providing a supply to the hydrostatic auxiliary relief field.

A first auxiliary relief field is preferably arranged in a tilting direction of the cylinder drum on the control disk.

This exemplary embodiment has the advantage that the specific operational disruption of the tilting of the cylinder drum is substantially prevented. As already described above, centrifugal forces are exerted on the drawn-out pistons in particular in the presence of very high rotational speeds of the cylinder drum of the hydrostatic axial piston machine, which centrifugal forces lead to tilting of the cylinder drum on the control disk. Said tilting is characterized by the cylinder drum lifting off at one side, resulting in a punctiform residual pressing force of the cylinder drum against the control disk. At that point of the control disk at which the punctiform residual pressing force (tilting point) is localized, there is arranged an auxiliary relief field for the purposes of compensating the acting residual pressing force. In this way, the axial piston machine can be operated without disruption in a relatively high rotational speed range. The auxiliary relief field preferably extends from the tilting point to both sides in the circumferential direction of the control disk.

The arrangement of the auxiliary relief field preferably enlarges a support circle radius in the tilting direction on the control disk by virtue of the auxiliary relief field being arranged radially at the outside at the edge of the control plate.

This has a particularly advantageous effect in preventing the tilting of the cylinder drum at very high rotational speeds. In addition to the compensation owing to the hydrostatic action of the auxiliary relief fields, the arrangement of the auxiliary relief field in the tilting direction enlarges the support circle radius. There are types of axial piston machine in which the cylinder drum, when it lifts off from the control disk, pivots about the outer edge of a support circle which is characterized by the outer diameter of the permanent relief field. By definition, the cylinder drum lifts off if the punctiform residual pressing force lies outside the support circle radius. Owing to the arrangement of the auxiliary relief field outside the permanent relief field, the support circle radius is enlarged. In this way, the tilt angle of the cylinder drum is reduced, and the lift-off rotational speed is shifted into a higher rotational speed range.

In many cases, the tilting direction is inclined at an angle (α) relative to a dead center axis or central axis of the control disk, wherein the value of the angle may lie in a range from 5-45°. The two dead centers are defined by the positions of the piston in the cylinder at which no axial movement is performed and the direction reversal of the piston takes place. The top and bottom dead centers are situated diametrically with respect to one another. If one transfers the two dead centers onto the control plate and connects these by way of a line, this forms the dead center axis or central axis. The auxiliary relief field is particularly preferably oriented correspondingly to said angle (α).

In a preferred refinement, a further auxiliary relief field is arranged diametrically with respect to the first auxiliary relief field.

A particular advantage of the diametric arrangement of two auxiliary relief fields is an additionally generated stability moment which serves for the compensation of the operation-dependent disturbance variables. In the event of tilting of the cylinder drum and associated oblique positioning, the pressure on the respective auxiliary relief field arranged in the tilting direction increases. By contrast, at the oppositely arranged auxiliary relief field, the pressure decreases. The resulting forces accordingly generate a stabilizing stability moment.

In principle, any relief field always involves a self-regulating effect. If the gap dimension between cylinder drum and control disk running surface becomes smaller in the presence of a constant volume flow, this leads to a pressure increase. The increased pressure results in an increase of the relief force and acts counter to the cylinder drum, which in turn leads to an increase of the gap dimension. With the gap enlargement, however, the pressure falls again, whereby the gap dimension decreases. This yields a type of self-regulating mechanism which is realized by way of the hydrostatic auxiliary relief field according to the disclosure. With the arrangement of two auxiliary relief fields arranged diametrically, these act with opposing self-regulation with respect to one another.

In general, a distinction can be made between three relief types (κ) which can be presented as per the formula:

Kₚᵤₘₚ=κₘₒₜₒᵣ+κ_{auxiliary relief}.

The permanent relief corresponds to the motor relief κₘₒₜₒᵣ. If the axial piston machine is operated as a pump, higher forces are generated on the control disk, whereby the motor power alone is not sufficient, and disturbance-free operation is not ensured. Accordingly, with the aid of the auxiliary relief field or auxiliary relief fields, additional relief κ_{auxiliary relief} in relation to the motor relief is realized. This altogether increased relief is referred to as pump relief κₚᵤₘₚ.

Here, values in the range of for example κₘₒₜₒᵣ=90-100% and κ_{auxiliary relief}=1-10% are preferably sought.

What is particularly preferable is a motor relief of approximately κₘₒₜₒᵣ=96% and an auxiliary relief of approximately κ_{auxiliary relief}=5%, which leads to a pump relief of κₚᵤₘₚ=101%.

### BRIEF DESCRIPTION OF THE DRAWINGS

Particularly preferred exemplary embodiments of the hydrostatic axial piston machine according to the disclosure are illustrated in the drawings. The disclosure will now be discussed in more detail on the basis of the figures of said drawings, in which:

FIG. 1 shows a first exemplary embodiment of the pressure medium supply of the auxiliary relief field on the control disk by way of a non-adjustable nozzle,

FIG. 2 shows a second exemplary embodiment of the auxiliary relief field according to the disclosure by way of an adjustable nozzle,

FIGS. 3a and 3b are schematic illustrations of the tilting of the cylinder drum in a radial view and an axial view,

FIG. 4 shows an exemplary embodiment of the control disk with an auxiliary relief field according to the disclosure arranged in the tilting direction,

FIG. 5 shows a further exemplary embodiment of a control disk with auxiliary relief field according to the disclosure, and

FIG. 6 shows a typical variable-rotational speed and variable-pressure load cycle of an axial piston machine according to the disclosure.

### DETAILED DESCRIPTION

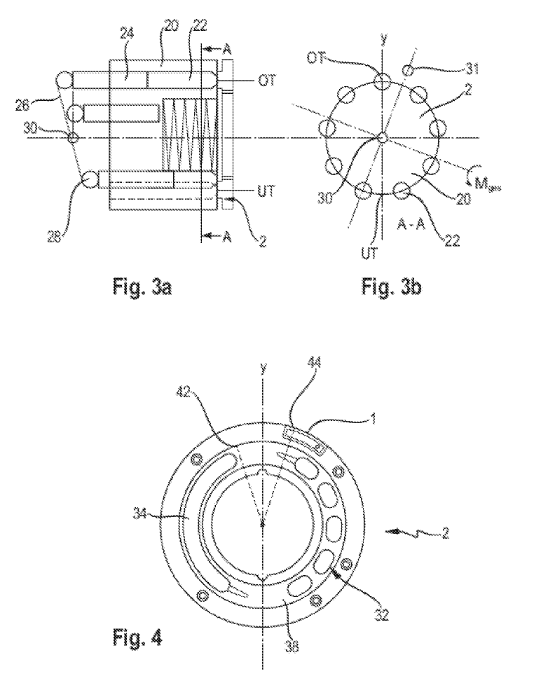

FIG. 1 shows an exemplary embodiment of the hydrostatic auxiliary relief field 1 of the hydrostatic axial piston machine on a control disk 2 which is, according to the disclosure, supplied with pressure medium by way of an auxiliary pump 4. The auxiliary relief field is arranged approximately centrally on the outer circumference of a high-pressure kidney-shaped control port 32, by way of which the cylinders of a cylinder drum (compare FIG. 3) are connected to the high-pressure side of the axial piston machine. Furthermore, the control disk 2 has a low-pressure kidney-shaped control port 34, by way of which the cylinder bores are connected to the low-pressure side. With regard to the underlying mode of operation of the axial piston machine, reference is made to the introductory part of the description and to FIG. 3. The high-pressure kidney-shaped control port 32, the low-pressure kidney-shaped control port and the auxiliary relief field 1 are situated in elevated regions of the control disk 2, against which the cylinder drum bears with a greater or lesser gap dimension. The elevated region in which the auxiliary relief field 1 is situated is very narrow and is separate from the elevated region in which the high-pressure kidney-shaped control port and the low-pressure kidney-shaped control port are situated. The gaps that arise between the elevated region surrounding the auxiliary relief field and the cylinder drum may be regarded as a nozzle via which pressure medium can flow out of the auxiliary relief field into the housing (not illustrated in any more detail) of the axial piston machine and which is denoted in the figures by the reference numeral 3.

The auxiliary relief field 1 is arranged on a control disk 2 at an angle of approximately 90° relative to the top dead center TDC of the piston position. In the exemplary embodiment as per FIG. 1, the supply of pressure medium to the auxiliary relief field 1 is realized by way of an auxiliary pump 4. The auxiliary pump 4 delivers pressure medium via a main line to a non-adjustable nozzle 6 and via the latter into the auxiliary relief field 1. The pressure medium flows out of the latter into the housing. The pressure in the main line between the auxiliary pump 4 and the nozzle 6 is measured by way of a manometer 8. An auxiliary line branches off from the main line, which auxiliary line is equipped with a pressure-limiting valve 12 which does not allow the pump pressure to increase beyond a particular value. This is realized by way of the drainage of excess pressure medium into a tank 14, which is open to the atmosphere. An auxiliary pump 4 is used which is such that it always delivers more pressure medium than flows out via the nozzles 6 and 3. The excess amount flows off via the pressure-limiting valve 12 into the tank. Thus, the pressure in the main line is equal to the pressure predefined by the pressure-limiting valve.

The relief pressure that prevails in the auxiliary relief field 1 is defined by pressure division by way of the nozzles 3 and 6. The latter nozzle 6 particularly preferably has a diameter of 4 mm. If, for example, the throughflow cross section of the nozzle 3 is equal to the throughflow cross section of the nozzle 6, the pressure in the auxiliary relief field 1 is equal to half of the pump pressure. If, by contrast, the cylinder drum lifts off slightly from the control disk, the throughflow cross section of the nozzle 3 becomes larger, and the pressure on the auxiliary relief field decreases. If the cylinder drum approaches the control disk in relation to a position with half pump pressure in the auxiliary relief field, the throughflow cross section of the nozzle 3 becomes smaller, and the pressure on the auxiliary relief field increases. This results in self-regulation of the pressure in the auxiliary relief field and thus self-regulation of the action of the auxiliary relief field. If the relief of the cylinder drum changes in the surface region surrounding the high-pressure kidney-shaped control port and the low-pressure kidney-shaped control port owing to a change in the rotational speed or the working pressure, the relief by way of the auxiliary relief field changes oppositely thereto.

A further secondary line with a 2/2-way valve 16 branches off from the main line. In an open position of the 2/2-way valve 16, the pressure medium can flow off out of the main line via the secondary line into the tank 14. The pressure in the main line and thus also in the auxiliary relief field is then the tank pressure. The auxiliary relief field is inactive. In the closed state of the 2/2-way valve 16, the pressure level and the main line is maintained.

The pressure prevailing at the auxiliary relief field 1 can be measured by way of a manometer 10. The manometers 8 and 10 are provided primarily for testing purposes.

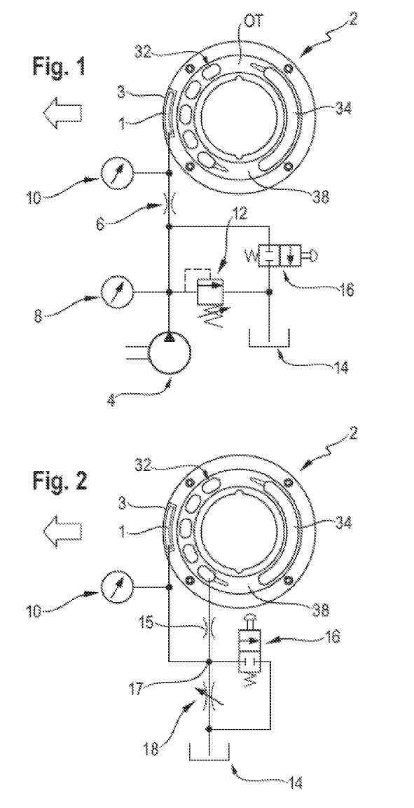

FIG. 2 shows a second exemplary embodiment, in which the hydrostatic pressure relief field 1 on the control disk 2 can be supplied with pressure medium via the high-pressure side of the axial piston machine. The illustrated control disk 2 from FIG. 2 is identical to the control disk 2 from FIG. 1. For the supply of pressure medium to the auxiliary relief field, pressure medium flows out of the high-pressure kidney-shaped control port 32 via a nozzle 15 with a constant throughflow cross section to a branching point 17, from which three lines extend. One line leads, without further throttle cross sections, to the auxiliary relief field 1. In terms of circuit layout, the auxiliary relief field 1 and the branching point 17 are the same. A second line leads to the tank 14. In the exemplary embodiment as per FIG. 1, a 2/2-way switching valve 16 is incorporated into said line. In an open position of the 2/2-way valve 16, the pressure medium flows off to the tank 14, which leads to a release of pressure and thus to a dissipation of the relief pressure in the auxiliary relief field 1, or prevents a pressure build-up in the auxiliary relief field 1. The pressure on the auxiliary relief field is then equal to the housing pressure, which in turn may be equal to a tank pressure. A third line likewise leads to the tank 14. A nozzle 18 with an adjustable throughflow cross section is incorporated into said line. Thus, the nozzle 18 and the nozzle 3, which is formed by the gaps between the edge of the auxiliary relief field 1 and the cylinder drum, are connected in parallel with one another. The nozzles 3 and 18 arranged in parallel with one another are in turn arranged in series with respect to the nozzle 15. In the closed position of the 2/2-way switching valve, the pressure in the auxiliary relief field 1 is defined by pressure distribution between the nozzle 15, on the one hand, and the nozzles 3 and 18, on the other hand. By way of the adjustable nozzle 18, it is possible for the effective cross section of the combination composed of the nozzles 3 and 18 connected in parallel to be varied. If a small throughflow cross section of the adjustable nozzle 18 is selected, the pressure in the auxiliary relief field 1 is higher than if the throughflow cross section of the adjustable nozzle 18 were selected to be relatively large. Furthermore, as in the exemplary embodiment as per FIG. 1, the throughflow cross section of the nozzle 3 self-evidently also influences the pressure level in the auxiliary relief field 1. If the throughflow cross section of the nozzle 3 is equal to zero, then only the nozzle 18 together with the nozzle 15 determines the pressure in the auxiliary relief field 1. By way of the adjustable nozzle 18, it is thus also possible to set a maximum pressure in the auxiliary relief field.

The pressure level at the auxiliary relief field 1 can be measured by way of the manometer 10.

FIGS. 3a and 3b show schematic illustrations of the axial piston machine. FIG. 3a is a longitudinal section of the axial piston machine, in particular of the cylinder drum 20 and of the control disk 2 against which the cylinder drum 20 bears. FIG. 3b shows the cylinder drum 20 in a cross section. It is possible to see the oblique positioning of a swashplate 26 of the axial piston machine. At the top dead center TDC, the piston 24 is situated in its deployed position in the cylinder 22. The bearing point 30 is the central point on the oblique axis 26. In the event of an increase of the rotational speed, the centrifugal forces acting on the piston 24 become continuously greater, such that, owing to the pistons 24 being deployed to different extents, the running surface of the cylinder drum 20 becomes seated increasingly obliquely on the running surface of the control disk 2, owing to the tilting moment M_{ges} as per FIG. 3b. The tilting point 31 is situated not at the top dead center TDC of the piston 24 on the dead center axis or central axis y but so as to be offset with respect thereto by an angle of approximately 15°.

The control disk 2 from FIG. 4 shows the arrangement of the auxiliary relief field 1 in the region of the tilting point 31 of the cylinder drum 20. This exemplary embodiment is preferably realized for the above described compensation or prevention of the tilting of the cylinder drum 20 on the control disk 2. The kidney-shaped control port 32 of the high-pressure side of the axial piston machine is equipped with intermediate webs. The kidney-shaped control port 34 of the low-pressure side is, by contrast, of continuous form. The auxiliary relief field 1 extends over an angle of approximately 5°-30° with respect to the dead center axis or central axis y. The permanent relief field 38 is formed over the entire circumference of the control disk 2 and corresponds to the motor relief. Together with the activated auxiliary relief field 1, a pump relief is realized. The arrangement of the auxiliary relief field 1 increases the support circle radius 42. As described, the cylinder drum 20, when it lifts off at one side, pivots about the outer edge of the support circle radius 42, which in the prior art is characterized by the outer diameter of the permanent relief field 38. This situation arises if the punctiform residual pressing force lies outside the support circle radius 42. Owing to the arrangement of the auxiliary relief field 1 radially outside the permanent relief field 38, the support circle radius 42 is increased, which corresponds to a new support circle radius 44 which extends to the outer edge of the auxiliary relief field 1.

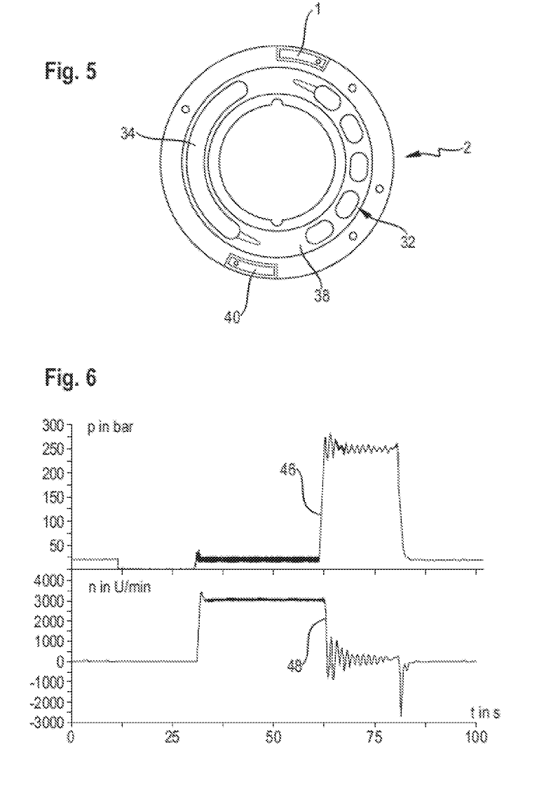

A control disk 2 with two diametrically arranged auxiliary relief fields 1 and 40 is shown in FIG. 5. The second auxiliary relief field 40 generates, together with the first auxiliary relief field 1, an additional stability moment for the compensation or prevention of the tilting of the cylinder drum 20 on the control disk 2. In the second auxiliary relief field 40, the pressure behaves oppositely to the first auxiliary relief field 1 owing to the above-described self-regulating effect. The matter of which pressure conditions prevail in the respective auxiliary relief field 1/40 is dependent on the respective oblique positioning of the cylinder drum 20 on the control disk 2. The control disk 2 as per 5 is suitable in particular for an axial piston machine with two-quadrant operation.

FIG. 6 shows a variable-rotational-speed and variable-pressure load cycle which is typically realized by way of an axial piston machine according to the disclosure. The upper curve shows the pressure profile 46 of the axial piston machine within the load cycle. By contrast, the lower curve shows the rotational speed profile 48 of the axial piston machine within the load cycle. It can be seen from the rotational speed profile 48 that, within the load cycle, the rotational speeds of the axial piston machine lie almost entirely in a range close to zero or in a very high range at around 3000 rpm. In these two situations, the above-discussed intensely varying rotational-speed-dependent disruptions arise, which it is sought to compensate by way of the one or more auxiliary relief fields 1 and 40 according to the disclosure, by virtue of said auxiliary relief field(s) being supplied with pressure medium in rotational-speed-dependent fashion according to the disclosure. Specific disruptions would, as already discussed in the introduction, be the omission of the hydrodynamic component of the permanent relief field 38 at low rotational speeds close to zero and the tilting of the cylinder drum 20 at high rotational speeds owing to the centrifugal forces of the deployed piston 24 in the cylinder 22 or the tilting of the cylinder drum 20 upon a change from motor operation to pump operation in the low rotational speed range.

### LIST OF REFERENCE DESIGNATIONS

1 Auxiliary relief field

2 Control disk

3 Nozzle

4 Auxiliary pump

6 Nozzle

8 Manometer p₁

10 Manometer p₂

12 Pressure-limiting valve

14 Tank

15 Nozzle

16 2/2-way valve

17 Branching point

18 Nozzle

20 Cylinder drum

22 Cylinder

24 Piston

26 Swashplate

28 Slide shoe bearing arrangement

30 Bearing point

31 Tilting point

32 High-pressure kidney-shaped control port

34 Low-pressure kidney-shaped control port

38 Permanent relief field

40 Second auxiliary relief field

42 Small support circle radius

44 Large support circle radius

46 Pressure profile

48 Rotational speed profile

α Angle

TDC Top dead center

BDC Bottom dead center

M_{ges} Tilting moment

y Dead center axis or central axis

What is claimed is:

1. A hydrostatic axial piston machine, comprising:
a control disk having a permanent relief field and at least one hydrostatic auxiliary relief field configured to be supplied with pressure medium; and
a cylinder drum supported on the control disk, the auxiliary relief field having a release pressure that is set in a manner dependent on a rotational speed of the cylinder drum.

2. The hydrostatic axial piston machine according to claim 1, wherein the at least one auxiliary relief field is configured for the compensation of rotational-speed-dependent disturbance variables.

3. The hydrostatic axial piston machine according to claim 1, wherein the pressure medium supply has a pressure medium flow limitation mechanism.

4. The hydrostatic axial piston machine according to claim 1, wherein the pressure medium is drawn or picked off via a high-pressure side of the axial piston machine.

5. The hydrostatic axial piston machine according to claim 1, wherein the at least one auxiliary relief field is configured to be connected to one or more of a hydraulic capacity and a hydraulic pump.

6. The hydrostatic axial piston machine according to claim 1, wherein the pressure medium is a discharged oil.

7. The hydrostatic axial piston machine according to claim 1, wherein a first auxiliary relief field is arranged in a tilting direction.

8. The hydrostatic axial piston machine according to claim 7, wherein the arrangement of the auxiliary relief field effects an enlargement of a support circle radius on the control disk.

9. The hydrostatic axial piston machine according to claim 7, wherein the tilting direction is inclined at an angle of approximately 5-45° relative to a dead center axis or central axis of the control disk.

10. The hydrostatic axial piston machine according to claim 7, wherein a second auxiliary relief field is arranged diametrically with respect to the first auxiliary relief field.

11. The hydrostatic axial piston machine according to claim 1, wherein the relief pressure of the auxiliary relief field is configured to be controlled or regulated as a function of the rotational speed of the cylinder drum.

12. The hydrostatic axial piston machine according to claim 8, wherein the tilting direction is inclined at an angle of approximately 5-45° relative to a dead center axis or central axis of the control disk.
